(19) United States
(12) Patent Application Publication
(10) Pub. No.: US 2018/0209791 A1
(43) Pub. Date: Jul. 26, 2018

(54) MOTION MEASUREMENT DEVICES AND METHODS FOR MEASURING MOTION

(71) Applicant: Agency for Science, Technology and Research, Singapore (SG)

(72) Inventor: Peter Hyun Kee CHANG, Singapore (SG)

(73) Assignee: Agency for Science, Technology and Research, Singapore (SG)

(21) Appl. No.: 15/742,726

(22) PCT Filed: Jul. 7, 2016
(86) PCT No.: PCT/SG2016/050315

§ 371 Date: Jan. 8, 2018

(30) Foreign Application Priority Data
Jul. 7, 2015 (SG) 10201505346X

(51) Int. Cl. G01C 19/5747; G01P 15/097

(52) U.S. Cl. CPC G01C 19/5747; G01P 15/097

(57) ABSTRACT

According to various embodiments, there is provided a motion measurement device including a first proof mass and a second proof mass, each of the first proof mass and the second proof mass configured to be at least partially rotatable in-plane; a pair of resonators arranged between the first proof mass and the second proof mass; wherein a first resonator of the pair of resonators is configured to resonate at a first frequency and a second resonator of the pair of resonators is configured to resonate at a second frequency; and a determination circuit configured to determine an acceleration based on the first frequency and the second frequency.

### CROSS-REFERENCE TO RELATED APPLICATIONS

This application claims the benefit of Singapore Patent Application number 10201505346X filed 7 Jul. 2015, the entire contents of which are incorporated herein by reference for all purposes.

### TECHNICAL FIELD

The present invention relates to motion measurement devices and methods for measuring motion.

### BACKGROUND

Capacitive sensing is commonly used in microelectromechanical systems (MEMS) sensor devices, such as sensor devices for sensing motion. For example, MEMS accelerometers may use capacitive sensing to detect the displacement of proof masses resulting from a linear acceleration-induced force. A small amount of charge may be collected from micro electrodes in the accelerometer. The small amount of charge, in other words, the electrical signal, may need to be amplified so as to obtain the acceleration measurement. The processes of amplification and demodulation used in conventional capacitive accelerometers may add noise at each processing step, resulting in noisy and unstable outputs. These noises may affect the accuracy of the generated linear position when the signal is integrated to generate the linear position in the linear three dimensional coordinate system. To improve the stability and sensitivity of the accelerometer or gyroscopes, a larger proof mass with flexible spring may be used in the accelerometer or gyroscopes. The quantity of electrodes may also be increased, with narrower gaps in between the electrodes. However, these improvement measures may cause the accelerometer to have a very narrow bandwidth mechanically with a lower dynamic range. The electrical linearity of the capacitive electrodes may also be degraded. The accelerometer may also become more sensitive to the fabrication process, thereby causing decreased yield and increased cost in fabricating the accelerometer. Some micro accelerometers designed for higher grade application may use feedback servo control to overcome the tradeoff problem between bandwidth and scale factor, as well as to guarantee the linearity of parallel capacitive electrodes. However this solution inevitably makes the accelerometer and the interfacing circuit more complex and more power-consuming with an increased amount of processing. Another type of accelerometer is a resonant accelerometer. The resonant accelerometer may be used mostly for high-end applications such as aerospace or military applications. The resonant accelerometer may use double ended tuning forks (DETFs) as detection resonators. The resonant accelerometer may directly measure the accelerating force by detecting splitting resonant frequencies of the differential DETFs which may allow better noise immunity from frequency processing and dramatically increase the dynamic range with superb linearity. DETFs may have a resonant frequency between 10 to 100 kHz with the size of several hundred μm sophisticated electrode structures for electrostatic driving and capacitive sensing. However, the physical structure of the resonant accelerometer may not be suitable for small size and multiple degree of freedom (DoF) integration applications.

MEMS gyroscopes may also employ capacitive sensing. MEMS gyroscopes may drive proof masses into oscillation using electrostatic driving, and then use capacitive sensing to detect the displacement of the vibrating proof masses resulting from the Coriolis force caused by the rotational rate. A small amount of charge may be collected from micro electrodes in the gyroscope. The small amount of charge, in other words, the electrical signal, essentially needs to be amplified and amplitude-demodulated so as to obtain the rate measurement. The processes of amplification and demodulation used in conventional capacitive gyroscope may add noise at each processing step, resulting in noisy and unstable outputs. All these noises also contribute to the drift of signal as a bias when the signal is integrated to generate the attitude (angle) information in the 3D rotational coordinate system. A two anti-phase driving or quad mass system may be used to reduce the anchor loss significantly, thereby increasing the mechanical scale factor by enhancing oscillation efficacy. Similar to the MEMS accelerometer, either a larger proof mass with flexible spring or more electrodes with narrower gaps may be used to improve the stability and sensitivity of the capacitive sensing element. However, the above improvement solution will lead to a very narrow bandwidth mechanically with lower dynamic range, degrade the electrical linearity, and also make the gyroscope more sensitive to the process window which results in decreased yield and increased manufacturing cost.

Therefore, there is a need for an improved MEMS motion measurement device that may avoid the drawbacks of the conventional MEMS capacitive inertial sensor devices.

### SUMMARY

According to various embodiments, there may be provided a motion measurement device including a first proof mass and a second proof mass, each of the first proof mass and the second proof mass configured to be at least partially rotatable in-plane; a pair of resonators arranged between the first proof mass and the second proof mass; wherein a first resonator of the pair of resonators is configured to resonate at a first frequency and a second resonator of the pair of resonators is configured to resonate at a second frequency; and a determination circuit configured to determine an acceleration based on the first frequency and the second frequency.

According to various embodiments, there may be provided a motion measurement device including a pair of unbalanced proof masses at least partially rotatable about a rotational axis; a pair of resonators arranged between the pair of unbalanced proof masses; wherein a first resonator of the pair of resonators is configured to resonate at a first frequency and a second resonator of the pair of resonators is configured to resonate at a second frequency; and a determination circuit configured to determine an acceleration based on the first frequency and the second frequency.

According to various embodiments, there may be provided a motion measurement device including a first frame and a second frame, each of the first frame and the second frame configured to be at least partially rotatable in-plane; a first pair of proof masses arranged within the first frame and a second pair of proof masses arranged within the second frame; a first driver circuit configured to drive the first pair of proof masses to oscillate in antiphase; a second driver circuit configured to drive the second pair of proof masses to oscillate in antiphase; a pair of resonators arranged between the first frame and the second frame; wherein a first resonator of the pair of resonators is configured to resonate at a first frequency and a second resonator of the pair of resonators is configured to resonate at a second frequency; and a determination circuit configured to determine a rotational rate, based on the first frequency, the second frequency and an oscillation rate of each of the first pair of proof masses and the second pair of proof masses.

According to various embodiments, there may be provided a method for measuring motion, the method including providing a first proof mass and a second proof mass, each of the first proof mass and the second proof mass configured to be at least partially rotatable in-plane; arranging a pair of resonators between the first proof mass and the second proof mass; wherein a first resonator of the pair of resonators is configured to resonate at a first frequency and a second resonator of the pair of resonators is configured to resonate at a second frequency; and determining an acceleration based on the first frequency and the second frequency.

According to various embodiments, there may be provided a method for measuring motion, the method including providing a pair of unbalanced proof masses, the pair of unbalanced proof masses being at least partially rotatable about a rotational axis; arranging a pair of resonators between the pair of unbalanced proof masses; wherein a first resonator of the pair of resonators is configured to resonate at a first frequency and a second resonator of the pair of resonators is configured to resonate at a second frequency; and determining an acceleration based on the first frequency and the second frequency.

According to various embodiments, there may be provided a method for measuring motion, the method including providing a first frame and a second frame, each of the first frame and the second frame configured to be at least partially rotatable in-plane; arranging a first pair of proof masses within the first frame; arranging a second pair of proof masses within the second frame; driving each of the first pair of proof masses and the second pair of proof masses to oscillate in antiphase; arranging a pair of resonators between the first frame and the second frame; wherein a first resonator of the pair of resonators is configured to resonate at a first frequency and a second resonator of the pair of resonators is configured to resonate at a second frequency; and determining a rotational rate based on the first frequency, the second frequency, an oscillation rate of the first pair of proof masses and an oscillation rate of the second pair of proof masses.

According to various embodiments, there may be provided a method for measuring motion, the method including providing a frame configured to be at least partially rotatable about a rotational axis; arranging a first proof mass in the frame at a first side of the rotational axis; arranging a second proof mass in the frame at a second side of the rotational axis; driving each of the first proof mass and the second mass to oscillate in antiphase; coupling a pair of resonators to the frame, the pair of resonators arranged between the first proof mass and the second proof mass; wherein a first resonator of the pair of resonators is configured to resonate at a first frequency and a second resonator of the pair of resonators is configured to resonate at a second frequency; and determining a rotational rate based on the first frequency, the second frequency, an oscillation rate of the first proof mass and an oscillation rate of the second proof mass.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments are described with reference to the following drawings, in which:

FIG. 1 shows a conceptual diagram of a motion measurement device according to various embodiments.

FIG. 2 shows a conceptual diagram of a motion measurement device according to various embodiments.

FIG. 3 shows a conceptual diagram motion measurement device according to various embodiments.

FIG. 4 shows a conceptual diagram of a motion measurement device according to various embodiments.

FIG. 5 shows a flow diagram of a method for measuring motion according to various embodiments.

FIG. 6 shows a flow diagram of a method for measuring motion according to various embodiments.

FIG. 7 shows a flow diagram of a method for measuring motion according to various embodiments.

FIG. 8 shows a schematic diagram of a motion measurement device according to various embodiments.

FIG. 9 shows a diagram showing a finite element model simulation of a square resonator.

FIG. 10 shows a diagram showing a FEM simulation of a ring resonator.

FIG. 11 shows a table listing the results from scale factor simulations from various different resonators using identical in-plane accelerometer structures.

FIG. 12 shows a motion measurement device according to various embodiments.

FIG. 13 shows a magnified view of FIG. 12, showing a flexure hinge of the motion measurement device.

FIG. 14 shows a graph showing simulation results of the sensitivity of the motion measurement device using square resonators.

FIG. 15 shows a graph showing simulation results of the sensitivity of the motion measurement device using ring resonators.

FIG. 16 shows a motion measurement device according to various embodiments.

FIG. 17 shows a graph showing simulation results of the sensitivity of the motion measurement device using square resonators.

FIG. 18 shows a graph showing simulation results of the sensitivity of the motion measurement device using ring resonators.

FIG. 19 shows a schematic diagram of a motion measurement device according to various embodiments.

FIG. 20A shows an in-phase motion amplifier according to various embodiments.

FIG. 20B shows an out-of-phase motion amplifier according to various embodiments.

FIG. 21 shows a schematic diagram of a motion measurement device according to various embodiments.

FIG. 22 shows a simulation diagram showing the stress load on the motion amplifiers of the motion measurement device when the proof mass is in motion.

FIG. 23 shows a diagram showing the behaviour of an in-phase motion amplifier according to various embodiments.

FIG. 24 shows a motion measurement device according to various embodiments.

FIG. 25 shows a diagram of the FEM simulation of the motion measurement device.

FIG. 26 shows a motion measurement device according to various embodiments.

FIG. 27 shows a diagram of the FEM simulation of the motion measurement device.

FIG. 28 shows a diagram of a motion measurement device according to various embodiments.

FIG. 29 shows an enlarged view of FIG. 28.

### DESCRIPTION

Embodiments described below in context of the motion measurement devices are analogously valid for the respective methods for measuring motion, and vice versa. Furthermore, it will be understood that the embodiments described below may be combined, for example, a part of one embodiment may be combined with a part of another embodiment.

It will be understood that any property described herein for a specific motion measurement device may also hold for any motion measurement device described herein. It will be understood that any property described herein for a specific method for measuring motion may also hold for any method for measuring motion described herein. Furthermore, it will be understood that for any motion measurement device or method for measuring motion described herein, not necessarily all the components or steps described must be enclosed in the device or method, but only some (but not all) components or steps may be enclosed.

In an embodiment, a “circuit” may be understood as any kind of a logic implementing entity, which may be special purpose circuitry or a processor executing software stored in a memory, firmware, or any combination thereof. Thus, in an embodiment, a “circuit” may be a hard-wired logic circuit or a programmable logic circuit such as a programmable processor, e.g. a microprocessor (e.g. a Complex Instruction Set Computer (CISC) processor or a Reduced Instruction Set Computer (RISC) processor). A “circuit” may also be a processor executing software, e.g. any kind of computer program, e.g. a computer program using a virtual machine code such as e.g. Java. Any other kind of implementation of the respective functions which will be described in more detail below may also be understood as a “circuit” in accordance with an alternative embodiment.

In the specification the term “comprising” shall be understood to have a broad meaning similar to the term “including” and will be understood to imply the inclusion of a stated integer or step or group of integers or steps but not the exclusion of any other integer or step or group of integers or steps. This definition also applies to variations on the term “comprising” such as “comprise” and “comprises”.

The term “coupled” (or “connected”) herein may be understood as electrically coupled or as mechanically coupled, for example attached or fixed, or just in contact without any fixation, and it will be understood that both direct coupling or indirect coupling (in other words: coupling without direct contact) may be provided.

In the context of various embodiments, “actuating element” may be but is not limited to being interchangeably referred to as an “actuator”.

In the context of various embodiments, “coupler” may be but is not limited to being interchangeably referred to as a “coupling element”.

In order that the invention may be readily understood and put into practical effect, particular embodiments will now be described by way of examples and not limitations, and with reference to the figures.

Capacitive sensing is commonly used in microelectromechanical systems (MEMS) sensor devices, such as sensor devices for sensing motion. For example, MEMS accelerometers may use capacitive sensing to detect the displacement of proof masses resulting from a linear acceleration-induced force. A small amount of charge may be collected from micro electrodes in the accelerometer. The small amount of charge, in other words, the electrical signal, may need to be amplified so as to obtain the acceleration measurement. The processes of amplification and demodulation used in conventional capacitive accelerometers may add noise at each processing step, resulting in noisy and unstable outputs. These noises may affect the accuracy of the generated linear position when the signal is integrated to generate the linear position in the linear three dimensional coordinate system. To improve the stability and sensitivity of the accelerometer or gyroscope, a larger proof mass with flexible spring may be used in the accelerometer or gyroscope. The quantity of electrodes may also be increased, with narrower gaps in between the electrodes. However, these improvement measures may cause the accelerometer to have a very narrow bandwidth mechanically with a lower dynamic range. The electrical linearity of the capacitive electrodes may also be degraded. The accelerometer may also become more sensitive to the fabrication process, thereby causing decreased yield and increased cost in fabricating the accelerometer. Some micro accelerometers designed for higher grade application may use feedback servo control to overcome the tradeoff problem between bandwidth and scale factor, as well as to guarantee the linearity of parallel capacitive electrodes. However this solution inevitably makes the accelerometer and the interfacing circuit more complex and more power-consuming with an increased amount of processing. Another type of accelerometer is a resonant accelerometer. The resonant accelerometer may be used mostly for high-end applications such as aerospace or military applications. The resonant accelerometer may use double ended tuning forks (DETFs) as detection resonators. The resonant accelerometer may directly measure the accelerating force by detecting splitting resonant frequencies of the differential DETFs which may allow better noise immunity from frequency processing and dramatically increase the dynamic range with superb linearity. DETFs may have a resonant frequency between 10 to 100 kHz with the size of several hundred μm sophisticated electrode structures for electrostatic driving and capacitive sensing. However, the physical structure of the resonant accelerometer may not be suitable for small size and multiple degree of freedom (DoF) integration applications.

MEMS gyroscopes may also employ capacitive sensing. MEMS gyroscopes may drive proof masses into oscillation using electrostatic driving, and then use capacitive sensing to detect the displacement of the vibrating proof masses resulting from the Coriolis force caused by the rotational rate. A small amount of charge may be collected from micro electrodes in the gyroscope. The small amount of charge, in other words, the electrical signal, essentially needs to be amplified and amplitude-demodulated so as to obtain the rate measurement. The processes of amplification and demodulation used in conventional capacitive gyroscope may add noise at each processing step, resulting in noisy and unstable outputs. All these noises also contribute to the drift of signal as a bias when the signal is integrated to generate the attitude (angle) information in the 3D rotational coordinate system. A two anti-phase driving or quad mass system may be used to reduce the anchor loss significantly, thereby increasing the mechanical scale factor by enhancing oscillation efficacy. Similar to the MEMS accelerometer, either a larger proof mass with flexible spring or more electrodes with narrower gaps may be used to improve the stability and sensitivity of the capacitive sensing element. However, the above improvement solution will lead to a very narrow bandwidth mechanically with lower dynamic range, degrade the electrical linearity, and also make the gyroscope more sensitive to the process window which results in decreased yield and increased manufacturing cost. Therefore, there is a need for an improved MEMS motion measurement device that may avoid the drawbacks of the conventional MEMS capacitive inertial sensor devices.

FIG. 1 shows a conceptual diagram of a motion measurement device 100 according to various embodiments. The motion measurement device 100 may include a first proof mass 102A and a second proof mass 102B, each of the first proof mass 102A and the second proof mass 102B may be configured to be at least partially rotatable in-plane. The motion measurement device 100 may further include a pair of resonators 104 arranged between the first proof mass 102A and the second proof mass 102B, wherein the first resonator of the pair of resonators 104 may be configured to resonate at a first frequency and a second resonator of the pair of resonators may be configured to resonate at a second frequency. The motion measurement device 100 may further include a determination circuit 106 configured to determine an acceleration based on the first frequency and the second frequency.

In other words, according to various embodiments, the motion measurement device 100 may include a first proof mass 102A, a second proof mass 102B, a pair of resonators 104 and a determination circuit 106. The first proof mass 102A may be at least substantially identical to the second proof mass 102B, in other words have the same mass. The first proof mass 102A may be distinct from the second proof mass 102B. The second proof mass 102B may mirror the first proof mass 102A, in other words, the first proof mass 102A and the second proof mass 102B may be mirror symmetric. The first proof mass 102A and the second proof mass 102B may also be referred herein as a pair of proof masses. The pair of proof masses may be configured to be at least partially rotatable in-plane. In other words, each of the first proof mass 102A and the second proof mass 102B may be able to rotate within a plane defined by them. Each of the first proof mass 102A and the second proof mass 102B may be coupled to an anchor arranged between the first proof mass 102A and the second proof mass 102B. Each of the first proof mass 102A and the second proof mass 102B may be coupled to the anchor via coupling elements. The coupling elements may be rigid so as to limit unwanted out-of-plane deflections of the first proof mass 102A and the second proof mass 102B. The pair of resonators 104 may include a first resonator and a second resonator, wherein the first resonator is at least substantially identical to the second resonator. Each of the first resonator and the second resonator may be coupled to each of the first proof mass and the second proof mass, for example via flexible couplers. Each flexible coupler may include a lever coupled to the proof mass and a flexure hinge coupled to the lever and the resonator. The pair of resonators 104 may be arranged between the pair of proof masses. The first resonator may resonate at a first frequency. The second resonator may resonate at a second frequency. When the motion measurement device 100 is stationary, the first frequency may be equal to the second frequency. When the motion measurement device 100 experiences a movement, such as an acceleration, the first frequency may differ from the second frequency. The determination circuit 106 may determine the acceleration based on the difference between the first frequency and the second frequency. The determination circuit 106 may be configured to determine the acceleration based on the amount of frequency shift in each of the first resonator and the second resonator. The motion measurement device 100 may be an accelerometer. The motion measurement device 100 may measure in-plane acceleration.

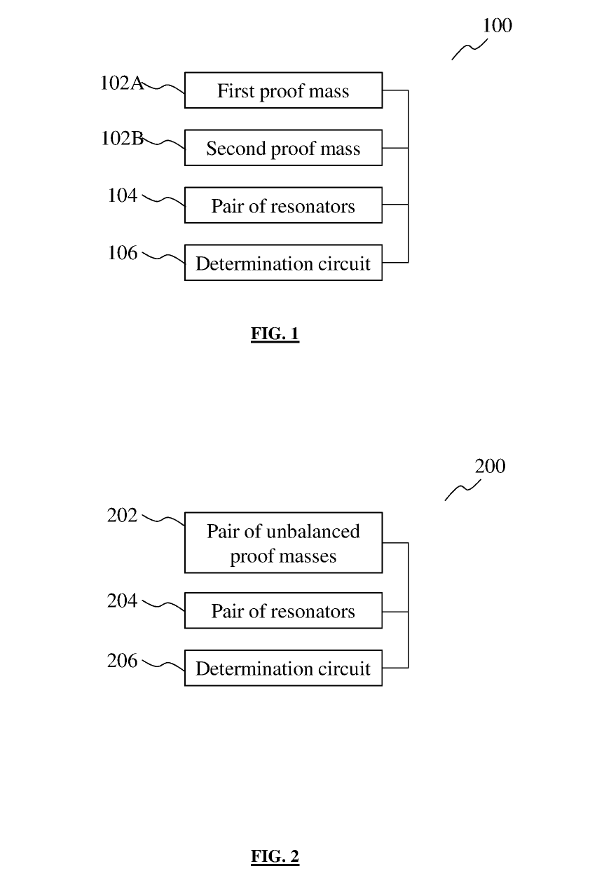

FIG. 2 shows a conceptual diagram of a motion measurement device 200 according to various embodiments. The motion measurement device 200 may include a pair of unbalanced proof masses 202, a pair of resonators 204 and a determination circuit 206. The pair of unbalanced proof masses 202 may be at least partially rotatable about a rotational axis. The pair of resonators 204 may be arranged between the pair of unbalanced proof masses 202. The pair of resonators 204 includes a first resonator and a second resonator. The first resonator may be configured to resonate at a first frequency. The second resonator may be configured to resonate at a second frequency. The determination circuit 206 may be configured to determine an acceleration based on the first frequency and the second frequency. The pair of unbalanced proof masses 202 may be coupled to an anchor via torsional couplers, so that the unbalanced proof masses 202 may be able to rotate about the rotational axis. When an out-of-plane acceleration is exerted on the motion measurement device 200, the pair of unbalanced proof masses 202 may alternately move out of plane in opposite directions.

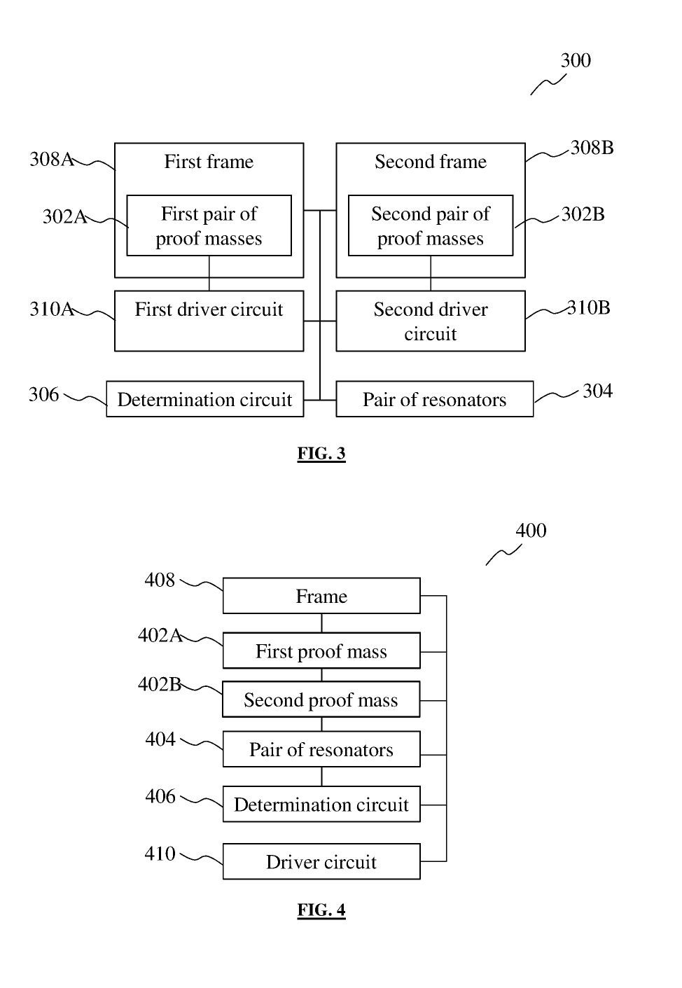

FIG. 3 shows a conceptual diagram of a motion measurement device 300 according to various embodiments The motion measurement device 300 may include a first frame 308A and a second frame 308B, each of the first frame 308A and the second frame 308B configured to be at least partially rotatable in-plane. In-plane may refer to motion that is at least substantially parallel to a plane of the motion measurement device 300 which may at least substantially planar such that it defines the plane. Each of the first frame 308A and the second frame 308B may be coupled to a fixed member by torsional couplers. The motion measurement device 300 may further include a first pair of proof masses 302A arranged within the first frame 308A and a second pair of proof masses 302B arranged within the second frame 308B. The first pair of proof masses 302A may be symmetrically arranged in the first frame 308A and the second pair of proof masses 302B may be symmetrically arranged in the second frame 308B. The motion measurement device 300 may further include a first driver circuit 310A configured to drive the first pair of proof masses 302A to oscillate in antiphase; and a second driver circuit 310B configured to drive the second pair of proof masses 302B to oscillate in antiphase. The oscillation of each of the first pair of proof masses 302A and the second pair of proof masses 302B may be in-plane, i.e. at least substantially parallel to a plane of the first frame 308A or the plane of the second frame 308B. Each of the first driver circuit 310A and the second driver circuit 310B may include motion amplifiers and actuating elements. Each of the first driver circuit 310A and the second driver circuit 310B may include two sets of motion amplifiers and two actuating elements. Each set of the motion amplifiers may be configured to oscillate a respective pair of proof masses in-plane, in other words in a direction at least substantially parallel to the plane of at least one of the first frame or the second frame. The motion amplifiers of the first driver circuit 310A may be coupled to the first pair of proof masses 302A and the actuating elements of the first driver circuit 310A. The motion amplifiers of the first driver circuit 310A may be configured to multiply the amount of deformation in the first pair of proof masses 302A. The motion amplifiers of the second driver circuit 310B may be coupled to the second pair of proof masses 302B and the actuating elements of the second driver circuit 310B. The motion amplifiers of the second driver circuit 310B may be configured to multiply an amount of deformation in the second pair of proof masses 302B. The plane of the first frame or the plane of the second frame may be at least substantially parallel to the plane of the motion measurement device. The motion measurement device 300 may further include a pair of resonators 304 arranged between the first frame 308A and the second frame 308B, wherein a first resonator of the pair of resonators 304 is configured to resonate at a first frequency and a second resonator of the pair of resonators 304 is configured to resonate at a second frequency. The motion measurement device 300 may further include a determination circuit 306 configured to determine a rate of motion, based on the first frequency, the second frequency, an oscillation rate of the first pair of proof masses 302A and an oscillation rate of the second pair of proof masses 302B. The first pair of proof masses 302A may be at least substantially identical to the second pair of proof masses 302B, in other words be similar in structure and mass. The first pair of proof masses 302A may be distinct from the second pair of proof masses 302B. Each of the first pair of proof masses 302A and the second pair of proof masses 302B may include the first proof mass 102A and the second proof mass 102B. The first driver circuit 310A may be at least substantially identical to the second driver circuit 310B. The second driver circuit 310A may be configured to drive the second pair of proof masses 302B to oscillate in antiphase relative to the first pair of proof masses 302A. The pair of resonators 304 may be at least substantially identical to the pair of resonators 104. A first physical arrangement including the first frame 308A, the first pair of proof masses 302A and the first driver circuit 310A may be at least substantially symmetric to a second physical arrangement including the second frame 308A, the second pair of proof masses 302B and the second driver circuit 310B. The motion measurement device 300 may be a gyroscope, i.e. the motion measurement device 300 may measure a rotational rate. The motion measurement device 300 may measure yaw rate.

FIG. 4 shows a conceptual diagram of a motion measurement device 400 according to various embodiments. The measurement device 400 may include a frame 408 configured to be at least partially rotatable about a rotational axis of the frame 408. The frame 408 may be coupled to a fixed member by each of a first torsional coupler and a second torsional coupler. The first torsional coupler may be coupled to the frame 408 at a mid-point of a first side of the frame 408. The second torsional coupler may be coupled to the frame 408 at a mid-point of a second side of the frame 408. The second side may oppose the first side. The measurement device 400 may further include a pair of proof masses arranged within the frame 408. The pair of proof masses may include a first proof mass 402A and a second proof mass 402B. The pair of proof masses may be symmetrically arranged in the frame 408. The pair of proof masses 402 may be configured to be stationary relative to the frame 408. The first proof mass 402A may be arranged in the frame 408 at a first side of the rotational axis. The second proof mass 402B may be arranged in the frame 408 at a second side of the rotational axis. The second side may oppose the first side. The measurement device 400 may further include a pair of resonators 404 coupled to the frame 40. The pair of resonators 404 may be arranged between the first proof mass 402A and the second proof mass 402B. A first resonator of the pair of resonators 404 may be configured to resonate at a first frequency. A second resonator of the pair of resonators 404 may be configured to resonate at a second frequency. The measurement device 400 may further include a determination circuit 406 configured to determine a rotational rate based on the first frequency, the second frequency and an oscillation rate of the pair of proof masses 402. The pair of resonators 404 may be at least substantially identical to the pair of resonators 404. The motion measurement device 400 may further include a driver circuit 410. The driver circuit 410 may be configured to drive each of the first proof mass 402A and the second proof mass 402B to oscillate in antiphase. The oscillation of the each of the first proof mass 402A and the second proof mass 402B may be at least substantially in-plane. The driver circuit 410 may drive the oscillation of the first proof mass 402A to be antiphase to the oscillation of the second proof mass 402B. The driver circuit 410 may include two sets of motion amplifiers and two actuating elements. One set of motion amplifiers may be coupled to a respective actuating element and may be further coupled to a respective proof mass. Each set of motion amplifiers may be configured to oscillate the respective proof mass in a direction at least substantially orthogonal to the plane of the frame 408. Each set of motion amplifiers may include a first motion amplifier configured to displace the respective proof mass in a first direction and a second motion amplifier configured to displace the respective proof mass in a second direction. The second direction may oppose the first direction. The motion measurement device 400 may be a gyroscope. The motion measurement device 400 may measure roll or pitch.

FIG. 5 shows a flow diagram 500 of a method for measuring motion according to various embodiments. The method may include processes 502, 504 and 506. In 502, a first proof mass and a second proof mass may be provided. Each of the first proof mass and the second proof mass may be configured to be at least partially rotatable in-plane. In 504, a pair of resonators may be arranged between the first proof mass and the second proof mass. A first resonator of the pair of resonators may be configured to resonate at a first frequency and a second resonator of the pair of resonators may be configured to resonate at a second frequency. In 506, an acceleration may be determined based on the first frequency and the second frequency.

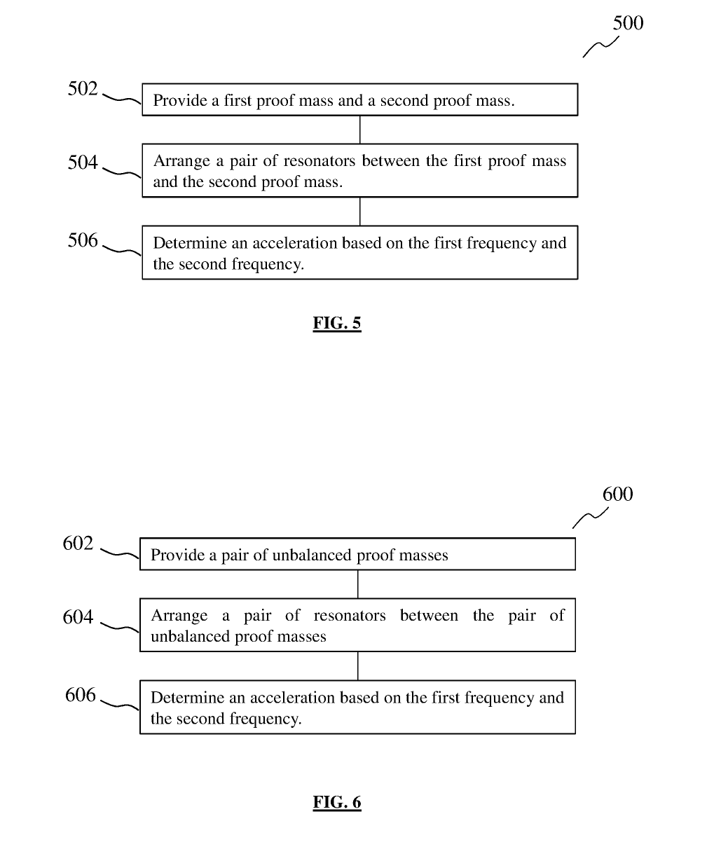

FIG. 6 shows a flow diagram 600 of a method for measuring motion according to various embodiments. The method may include processes 602, 604 and 606. In 602, a pair of unbalanced proof masses may be provided. The pair of unbalanced proof masses may be at least partially rotatable about a rotational axis. The pair of unbalanced proof masses may include a first proof mass and a second proof mass, wherein the first proof mass and the second proof mass differ in mass. In 604, a pair of resonators may be arranged between the pair of unbalanced proof masses. A first resonator of the pair of resonators may be configured to resonate at a first frequency. A second resonator of the pair of resonators may be configured to resonate at a second frequency. In 606, an acceleration may be determined based on the first frequency and the second frequency.

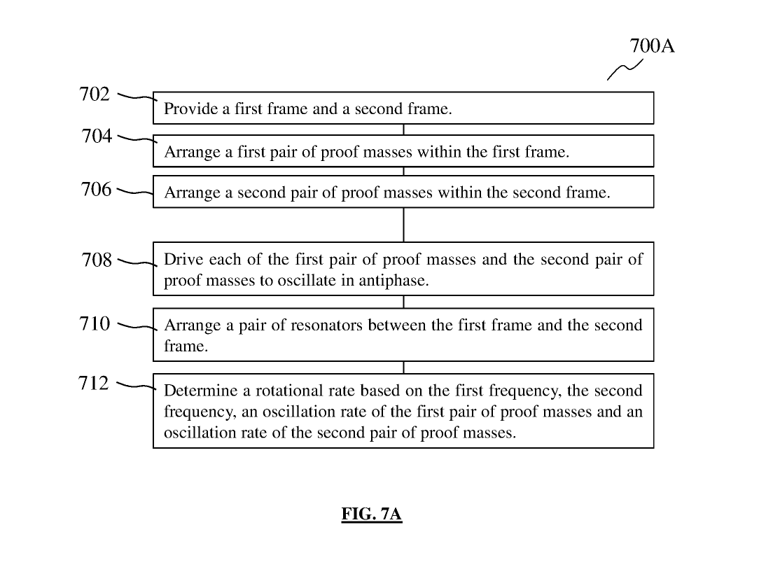

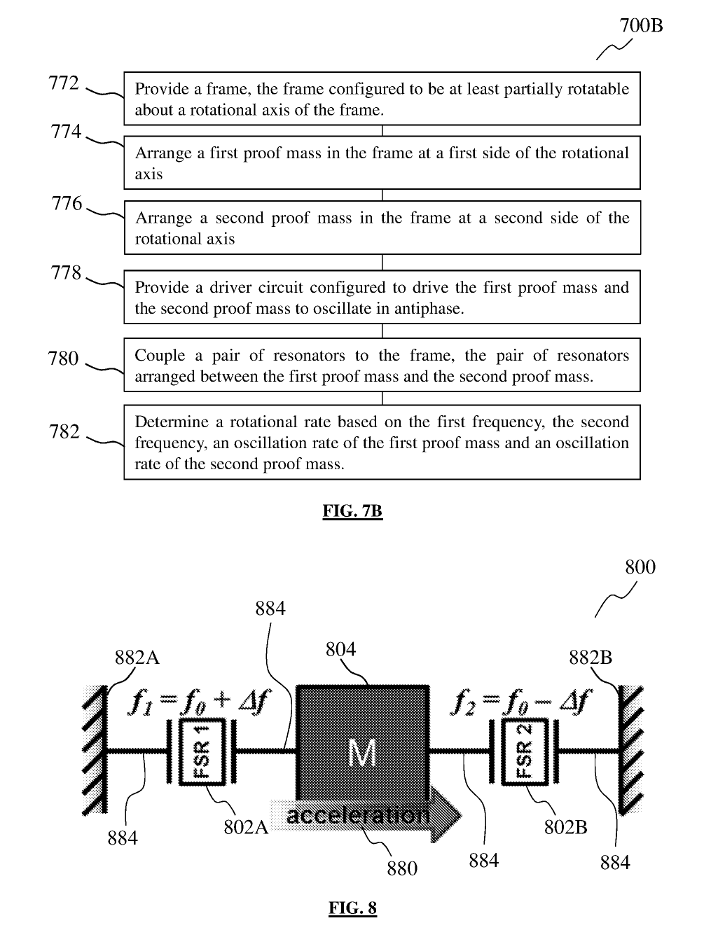

FIG. 7A shows a flow diagram 700A of a method for measuring motion according to various embodiments. The method may include processes 702, 704, 706, 708, 710 and 712. In 702, a first frame and a second frame may be provided, each of the first frame and the second frame configured to be at least partially rotatable in-plane. In 704, a first pair of proof masses may be arranged within the first frame. In 706, a second pair of proof masses may be arranged within the second frame. In 708, each of the first pair of proof masses and the second pair of proof masses may be driven to oscillate in antiphase. In 710, a pair of resonators may be arranged between the first frame and the second frame. A first resonator of the pair of resonators may be configured to resonate at a first frequency. A second resonator of the pair of resonators may be configured to resonate at a second frequency. In 712, a rotational rate may be determined based on the first frequency, the second frequency, an oscillation rate of the first pair of proof masses and an oscillation rate of the second pair of proof masses.

FIG. 7B shows a flow diagram 700B of a method for measuring motion according to various embodiments. The method may include processes 772, 774, 776, 778, 780 and 782. In 772, a frame may be provided. The frame may be configured to be at least partially rotatable about a rotational axis of the frame. In 774, a first proof mass may be arranged in the frame at a first side of the rotational axis. In 776, a second proof mass may be arranged in the frame at a second side of the rotational axis. The second side may be opposite to the first side. In 778, driving each of the first proof mass and the second proof mass to oscillate in antiphase. In 780, a pair of resonators may be coupled to the frame. The pair of resonators may be arranged between the first proof mass and the second proof mass. A first resonator of the pair of resonators may be configured to resonate at a first frequency and a second resonator of the pair of resonators may be configured to resonate at a second frequency. In 782, a rotational rate may be determined based on the first frequency, the second frequency and an oscillation rate of the first proof mass and an oscillation rate of the second proof mass.

According to various embodiments, a motion measurement device may be configured to measure a direction, a speed or an acceleration of a motion. The motion measurement device may be at least substantially planar in shape, such that the motion measurement device itself defines a plane. The motion measurement device may be configured to measure motion that is at least substantially parallel to the plane, i.e. in-plane motion. The motion measurement device may be configured to measure motion that is at least substantially perpendicular to the plane, i.e. out-of-plane motion.

According to various embodiments, a motion measurement device may be configured to measure at least one of acceleration or rotation rate. The rotation may be one of yaw, roll or pitch motion.

According to various embodiments, a motion measurement device may include a pair of differential resonators between two proof masses. The two proof masses may be symmetric. The two proof masses may have in-plane rotational freedom.

According to various embodiments, a motion measurement device may include a pair of differential resonators coupled to one side of a rotational axis of an unbalanced proof mass. The unbalanced proof mass may be configured to rotate about the rotational axis. The unbalanced proof mass may have out-of-plane rotational freedom and may move alternately in opposite directions in a see-saw like motion when exposed to out-of-plane acceleration.

According to various embodiments, a motion measurement device may include two resonators placed in between two symmetric inertial frames. Each inertial frame may include a pair of proof masses that may each be driven to oscillate in-plane. Each pair of proof masses may be driven in anti-phase.

According to various embodiments, a motion measurement device may include two resonators coupled to one side of a rotational frame. The rotational frame may be configured to have out-of-plane rotational freedom about a rotational axis. The rotational axis may coincide with a centre line of the rotational frame. The rotational frame may be anchored by torsional springs. Two proof masses may be arranged in the rotational frame, wherein one proof mass is arranged at one side of the rotational axis. In other words, the two proof masses are arranged at opposing sides of the rotational axis. The two proof masses may be driven anti-phase, to oscillate in-plane.

According to various embodiments, a motion measurement device may be an accelerometer. The motion measurement device may include a plurality of resonators which may be differential resonators. The resonators may be force sensitive resonators (FSR). In other words, the resonant frequency of the resonators may be dependent on an amount of force applied on the resonators. The motion measurement device may include structural features such as frames and couplers. The structural features may be symmetrically arranged. The resonators may include piezoelectric material, such as aluminum nitride. The resonators may be arranged in pairs of resonators, so that the pair of resonators may be configured for differential sensing. The motion measurement device may directly sense the force exerted on the motion measurement device by measuring the amount of frequency shift exhibited the pair of resonators. Two splitting frequency may be multiplied for demodulation to remove the original resonant frequency of the resonators. The original resonant frequency of the resonators may be influenced by external factors such as environmental factors including temperature and damping scenarios. Therefore, by removing the original resonant frequency of the resonators, the motion measurement device may self-calibrate or compensate for the external factors. In other words, the accuracy of the motion measurement device may be free from external factors. The simulated frequency scale factor of an in-plane accelerometer may be about 200 Hz/g from 1×0.5 m^{m2}.

According to various embodiments, a motion measurement device may include two specific resonators for force sensing. The motion measurement device may include a specific accelerometer structure. The accelerometer structure may include three individual single-axis accelerometers. The accelerometer structure may alternatively be a single-structure capable of sensing motion in three-axes. The motion measurement device may include modularized resonators. The motion measurement device may further include force amplifying levers. The motion measurement device may be configured to measure one of an in-plane acceleration or an out-of-plane acceleration. The plane may be defined by the proof masses or the motion measurement device. The motion measurement device may be at least substantially planar. The motion measurement device may show high frequency scale factor with good linearity, as compared to conventional resonant accelerometers.

According to various embodiments, a motion measurement device may be a gyroscope. The motion measurement device may be configured to measure orientation. The motion measurement device may be configured to measure a rate of at least one of yaw, pitch or roll. The motion measurement device may include a plurality of resonators, such as FSRs. The resonators may be arranged in pairs, so that each pair may be a differential resonator. The motion measurement device may make use of the principle of frequency modulation. The motion measurement device may include a gyroscope structure. The resonators may be fabricated using piezoelectric material such as aluminum nitride. Two signals from resonators may be demodulated to remove the resonant frequency which may be prone to environmental effects. The gyroscope structure may directly sense the Coriolis force experienced by proof masses in the motion measurement device. The Coriolis force may be sensed by measuring the amount of frequency shift in the resonators. The frequencies of each resonator in a pair of differential resonators may be demodulated to remove the original resonant frequency of the resonators which needs compensation to remove the effect of environmental factors such as temperature and different damping situation. The simulated frequency scale factor of a motion measurement device configured to measure yaw rate may be about 5 Hz/°/s and the calculated frequency at 2,000°/s input may be about 12 kHz from an 1×1 mm² area.

According to various embodiments, a motion measurement device may include a driver circuit. The driver circuit may include an actuator. The driver circuit may further include a motional amplifier. The actuator may be powered by piezoelectricity. In other words, the actuator may include piezoelectric materials. The actuator may convert electricity into kinetic energy.

According to various embodiments, a motion measurement device may include mechanical amplifiers. The mechanical amplifiers may include at least one of a motion amplifier or a force amplifier. The force amplifier may be connecting levers arranged between the resonators and the proof masses or the inertial frame. The motion amplifier may be structures for driving motion of the proof masses.

FIG. 8 shows a schematic diagram of a motion measurement device 800 according to various embodiments. The motion measurement device 800 may be the motion measurement device 100. The motion measurement device 800 may be configured to measure acceleration. In other words, the motion measurement device 800 may be an accelerometer. The motion measurement device 800 may include a pair of differential resonators and a proof mass 804 coupled to the pair of differential resonators. The pair of differential resonators may include resonators 802A and 802B. The resonator 802A may be at least substantially identical to the resonator 802B, in other words, the resonator 802A and the resonator 802B may be a same type of resonator. For example, both resonators 802A and 802B may be ring resonators, or may both be square resonators. The pair of differential resonators may be at least substantially similar or identical to the pair of resonators 104, 204 and 304. The pair of differential resonators may be force sensitive resonators (FSR), also referred herein as force sensing resonators. The resonators 802A and 802B are labelled as FSR 1 and FSR 2, respectively in FIG. 8. The proof mass 804 may have a first end coupled to the resonator 802A and may have a second end coupled to the resonator 802B. The first end may oppose the second end. The resonator 802A may have an anchored end and a coupling end, wherein the anchored end may oppose the coupling end. The anchored end may be affixed to an anchor 882A via a coupler 884. The coupling end may be coupled to the proof mass 804 via a coupler 884. The resonator 802B may similar have an anchored end and a coupling end, wherein the anchored end is coupled to an anchor 882B via a coupler 884, wherein the coupling end is coupled to the proof mass 804 via a coupler 884.

The resonators 802A and 802B may detect opposite polarities of an inertial acceleration 880. For example, if the acceleration 880 is towards the resonator 802B, the resonator 802A may experience tensile stress while the resonator 802B may experience compressive stress. The natural frequency, i.e. resonance frequency of the resonators 802A and 802B may be denoted as f₀. The oscillation frequency of the resonator 802A may be denoted as f₁ and may be expressed as f₁=f₀+Δf. The oscillation frequency of the resonator 802B may be denoted as f₂ and may be expressed as f₂ f₀−Δf. Therefore, the difference between f₁ and f₂ is 2Δf. The value of 2Δf may be detected and processed after differentiation. The acceleration measurement may be determined based on the value of Δf. The complex mechanism between force and natural frequency of the resonator may be explained using energy conservation at resonance. At resonance, energy is converted to and fro between two different kinds of energies while conserving the total amount of energy. For example, a simple spring-mass-damper system may convert energy between potential energy stored in springs and kinetic energy in the oscillating proof masses. The damper may reduce the total amount of energy in every cycle from the system. In other words, the damper may convert part of the energy into other forms of energy that are neither potential energy nor kinetic energy, for example heat energy. The damper therefore may account for the energy loss from the system. The ratio of energy loss in every cycle to the total amount of energy is the damping ratio. The reciprocal of the damping ratio is the quality factor (Q-factor) of the system. A high Q-factor indicates that energy loss is low. Two types of force sensing resonators have been designed and tested for the simulation of acceleration sensing.

FIG. 9 shows a diagram 900 showing a finite element model (FEM) simulation of a square resonator 992. The square resonator 992 may be a bulk acoustic wave (BAW) resonator. The square resonator 992 may be configured to resonate in Lame mode. The square resonator 992 may be coupled to a plurality of couplers 884, for example a coupler 884 at each corner of the square resonator 900 as shown in the diagram 900. The couplers 884 may be provided in the form of connecting rods. The couplers 884 may be configured to bridge the corners of the square resonator 992 to anchors or proof masses directly. The anchors may be the anchors 882A or 882B of FIG. 8. The proof masses may be the proof masses 804 of FIG. 8. The couplers 884 may alternatively be configured to couple the square resonator 992 to the anchors or the proof masses indirectly through a mechanical lever structure. The mechanical lever structure may be a V-shaped structure. The square resonator 992 has been simulated to have a high Q-factor and a good frequency scale factor. The diagram 900 includes a scale 994 showing how the different colours on the heatmap indicate different values of the displacement. Although the colours of the heatmap may not be clearly visible in the black and white version of the drawing, it should be noted that the centre of the square resonator 992 has the lowest values while the coupling points between the square resonator 992 and each anchor 884 has the highest values.

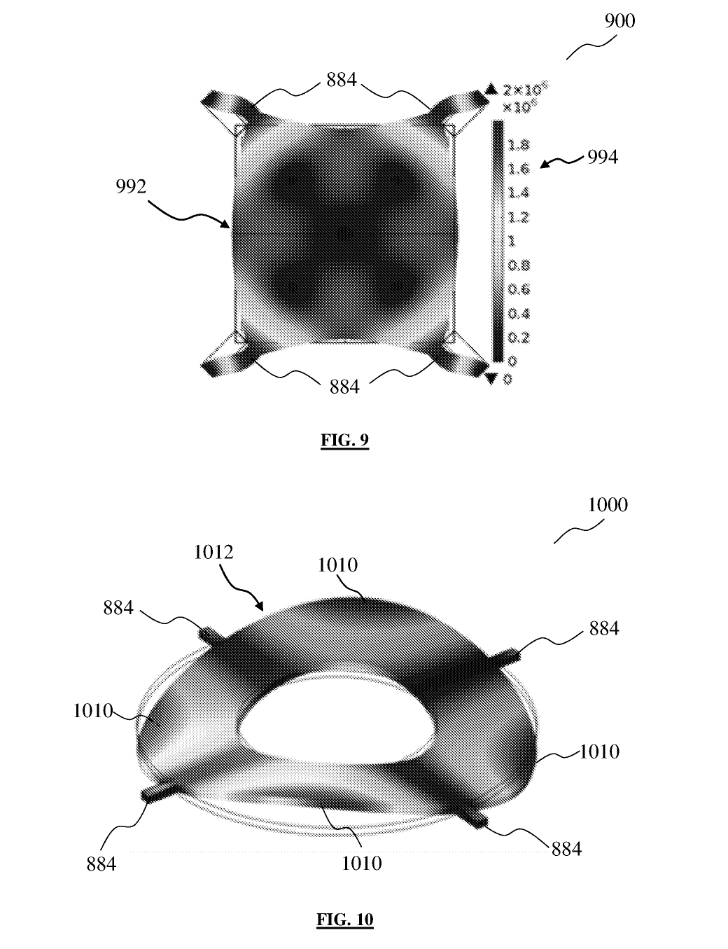

FIG. 10 shows a diagram 1000 showing a FEM simulation of a ring resonator 1012. The ring resonator 1012 may be configured to resonate in torsional wine glass mode. The ring resonator 1012 may be coupled to couplers 884. The couplers 884 may be identical to the couplers in FIG. 9. The couplers 884 may be coupled to the ring resonator 1012 at four quasi nodal points of the ring resonator 1012 at torsional wineglass resonance. The torsional wineglass mode has been selected as it exhibits higher frequency scale factor than in-plane wineglass mode with more than 40% of mode separation from each other. Mode separation with the wineglass mode has been conducted by adjusting the geometry of the four couplers 884. Although the colours of the heatmap may not be clearly visible in the black and white version of the drawing, it should be noted that the quasi nodal points where the ring resonator 1012 is affixed to couplers 884 exhibit the lowest values while the circumferential mid points 1010 between the quasi nodal points exhibit the highest values. The simulations shown in FIGS. 9 and 10 have demonstrated that sensitivity of more than 200 Hz/g with less than 0.02% of nonlinearity within ±16 g may be achieved. The linearity may be maintained at up to more than 1,000 g.

FIG. 11 shows a table 1100 listing the results from scale factor simulations from various different resonators using identical in-plane accelerometer structures. Each of the listed accelerometer structure may include the same proof mass and couplers. The proof mass used for the simulations is a 100 μm-thick layer of silicon. The proof mass may be the proof mass 804 of FIG. 8. The couplers may be the couplers 884 and may be springs. The table 1100 includes three columns, namely a first column 1102 indicating the resonator type; a second column 1104 indicating the resonant mode; and a third column 1106 indicating the frequency scale factor obtained from the scale factor simulations. The table 1100 includes a first row 1108 indicating the conventional DETF resonator resonating in the flexural tuning fork mode; a second row 1110 indicating the ring resonator resonating firstly in the in-plain wineglass mode and secondly in the torsional wineglass mode; and a third row 1112 indicating the square resonator resonating firstly in wineglass mode and secondly in Lame mode. As shown in the table 1100, the ring resonator and the square resonator exhibited higher sensitivity, in other words, frequency scale factor, than the conventional DETF resonator. Also, the ring resonator exhibited higher frequency scale factor when it resonates in torsional wineglass mode as compared to when it resonates in in-plane wineglass mode. The square resonator exhibited higher frequency scale factor when it resonates in Lame mode as compared to when it resonates in wineglass mode. In view of their superior frequency scale factor, the ring resonator oscillating in torsional wineglass mode and the square resonator oscillating in Lame mode were selected for the sensor design and FEM analysis.

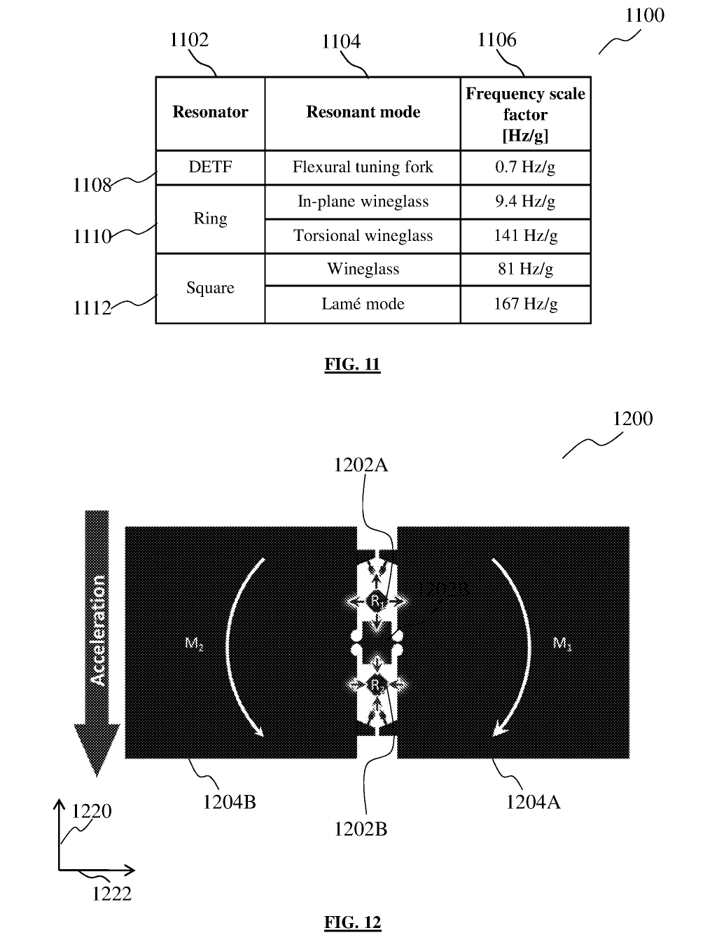

FIG. 12 shows a motion measurement device 1200 according to various embodiments. The motion measurement device 1200 may be at least substantially identical or similar to the motion measurement device 100. The motion measurement device 1200 may be an in-plane accelerometer. The structure shown in FIG. 12 may be a simplified structure, showing the detection mechanism. The motion measurement device 1200 may include a pair of proof masses. The pair of proof masses may be any one of the pair of proof masses 302, or the first pair of proof masses 202A or the second pair of proof masses 202B. The pair of proof masses may include a first mass 1204A indicated in FIG. 12 as M₁ and a second mass 1204B indicated in FIG. 12 as M₂. The first mass 1204A may be at least substantially identical to the second mass 1204B. The first mass 1204A may be the first proof mass 102A. The second mass 1204B may be the second proof mass 102B. Each of the first mass 1204A and the second mass 1204B may be the proof mass 804 of FIG. 8. The motion measurement device 1200 may further include a pair of resonators. The pair of resonators may be the pair of resonators 104, 204 or 304. The pair of resonators may include the resonators 802A and 802B of FIG. 8. The pair of resonators may include a first resonator 1202A which is marked as R₁ and a second resonator 1202B which is marked as R₂. Each of the first proof mass 1204A and the second proof mass 1204B may be coupled to an anchor via coupling elements. The coupling elements may be rigid so as to limit the out-of-plane movement of the first proof mass 1204A and the second proof mass 1204B. The first proof mass 1204A and the second proof mass 1204B may be restrained from unwanted out-of-plane movements through the coupling to the anchor. The anchor may be arranged between the first proof mass 1204A and the second proof mass 1204B. The pair of resonators may be coupled to the proof masses through flexible couplers. A flexible coupler may include a lever connected to a flexure hinge. The lever may be connected to one of the proof masses while the flexure hinge may be connected to one of the resonators. The motion measurement device 1200 may include the pair of resonators and the pair of proof masses so as to enable symmetric interaction between the proof masses and the differential resonators. When acceleration is exerted along a first axis 1220, the first mass 1204A and the second mass 1204B may tilt in mirrored directions to stretch one resonator and to squeeze the other resonator. For example, when the acceleration is in a downward direction along the first axis 1220 as illustrated in FIG. 12, the first mass 1204A may tilt in a clockwise direction and the second mass may tilt in an anti-clockwise direction. As a result, the first resonator 1202A may be stretched and the second resonator 1202B may be squeezed. The motion measurement device 1200 may further include a determination circuit that computes the acceleration from the respective new resonant frequencies of the first resonator 1202A and the second resonator 1202B.

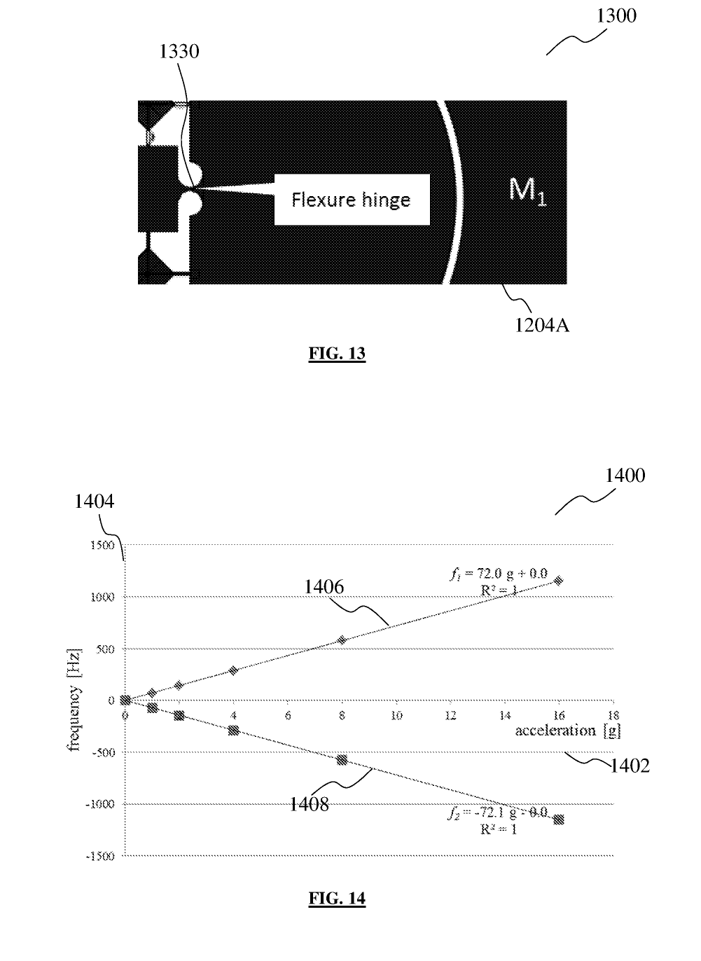

FIG. 13 shows a magnified view of FIG. 12, showing a flexure hinge 1330 of the motion measurement device 1200. The flexure hinge 1330 may be a coupler or a coupling element configured to couple the first mass 1204A and the second mass 1204B to the pair of resonators. The flexure hinge 1330 may be positioned at a mid-point of each of the first mass 1204A and the second mass 1204B. The flexure hinge 1330 may include a flexible, spring-like material such that each of the first mass 1204A and the second mass 1204B connected to the flexure hinge 1330 may be able to rotate. In other words, the first mass 1204A and the second mass 1204B may have rotational degree of freedom. The flexure hinge 1330 may be a thin tether that connects the resonator to levers that are coupled to the first mass 1204A and the second mass 1204B. The levers may include a slope to amplify any force received. The rotation of the pair of proof masses may be limited to a rotation plane, the rotation plane being at least substantially parallel to a plane in which the acceleration occurs. In other words, the rotation plane may be at least substantially parallel to each of the first axis 1220 and the second axis 1222. A simplified structure of the motion measurement device 1200 may be simulated using FEM.

FIG. 14 shows a graph 1400 showing simulation results of the sensitivity of the motion measurement device 1200 using square resonators 992. The square resonators 992 are resonating in Lame mode. In other words, the graph 1400 shows the scale factor simulation of the motion measurement device 1200, wherein the resonators 1202A and 1202B are square resonators 992. The graph 1400 includes a horizontal axis 1402 and a vertical axis 1404. The horizontal axis 1402 may represent acceleration in units of standard gravity (g). The vertical axis 1404 may represent frequency in hertz (Hz). The graph 1400 further includes a first plot 1406 indicating the oscillation frequencies of the first resonator 1202A; and a second plot 1408 indicating the oscillation frequencies of the second resonator 1202B. The gradient of the second plot 1408 is at least substantially equal to an opposite of the first plot 1406. Also, each of the first plot 1406 and the second plot 1408 may be linear. In other words, the oscillation frequency of each resonator is at least substantially directly proportional to the acceleration experienced by the motion measurement device 1200. The graph 1400 shows that the motion measurement device 1200 using square resonators 992 resonating in Lame mode may achieve less than 0.1% non-linearity. In a further simulation, it was shown that the motion measurement device 1200 may achieve less than 0.1% non-linearity up to 1,000 g.

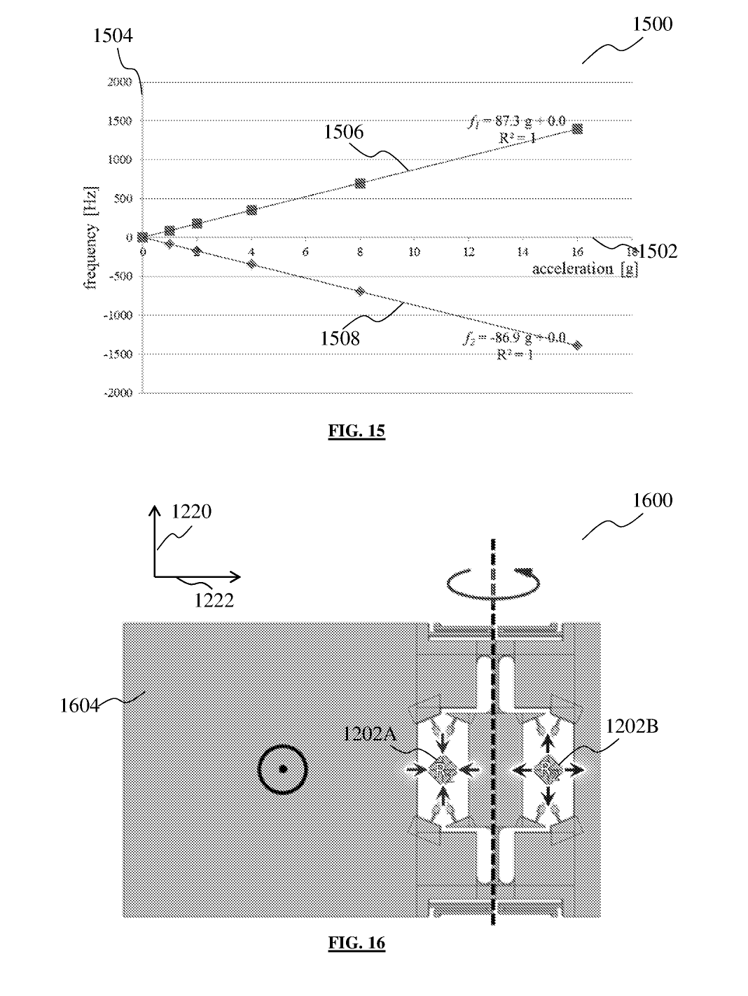

FIG. 15 shows a graph 1500 showing simulation results of the sensitivity of the motion measurement device 1200 using ring resonators 1012. In other words, the graph 1500 shows the scale factor simulation of the motion measurement device 1200, wherein the resonators 1202A and 1202B are ring resonators 1012. The ring resonators 1012 are resonating in torsional wineglass mode. The graph 1500 includes a horizontal axis 1502 and a vertical axis 1504. The horizontal axis 1502 may represent acceleration in units of g. The vertical axis 1504 may represent frequency in hertz (Hz). The graph 1500 further includes a first plot 1506 indicating the oscillation frequencies of the first resonator 1202A; and a second plot 1508 indicating the oscillation frequencies of the second resonator 1202B. The gradient of the second plot 1508 is at least substantially equal to an opposite of the first plot 1506. Also, each of the first plot 1506 and the second plot 1508 may be linear. In other words, the oscillation frequency of each resonator is at least substantially directly proportional to the acceleration experienced by the motion measurement device 1200. The graph 1500 shows that the motion measurement device 1200 using ring resonators 1012 resonating in torsional wine glass mode may achieve less than 0.1% non-linearity 1,000 g from the scale factor simulation.

FIG. 16 shows a motion measurement device 1600 according to various embodiments. The motion measurement device 1600 may be at least substantially identical or similar to the motion measurement device 200. The motion measurement device 1600 may be an out-of-plane accelerometer. The diagram showed in FIG. 16 may be a simplified structure of the motion measurement device 1600. The motion measurement device 1600 may include a pair of differential resonators which may be the pair of resonators 204. The pair of differential resonators may include a first resonator 1202A and a second resonator 1202B. Each of the first resonator 1202A and the second resonator 1202B may be FSRs. The motion measurement device 1600 may include a pair of proof masses 1604. The proof masses 1604 may be the pair of unbalanced proof masses 202. The proof mass 1604 may be unbalanced such that it may rotate in a roll direction or a pitch direction when out-of-plane acceleration is applied. The proof masses 1604 may be coupled to an anchor via torsional couplers. The anchor may be arranged between the pair of proof masses. The pair of proof masses 1604 may rotate about a rotational axis in a see-saw like movement. The see-saw like movement may be an out-of-plane movement. The first proof mass and the second proof mass may further be coupled to the frame with rigid coupling elements to limit unwanted in-plane deflections. The torsional couplers may be torsional springs. The first resonator 1202A and the second resonator 1202B may be arranged on either side of the proof mass 1604. Each of the first resonator 1202A and the second resonator 1202B may be coupled to the proof mass 1604 via a coupling element. The coupling element may include a lever and a flexure hinge. When an out-of-plane acceleration is applied, the proof mass 1604 may tilt in a see-saw mode. The plane is defined as the plane of the proof mass 1604. The plane may be at least substantially parallel to each of the first axis 1220 and the second axis 1222. In FIG. 16, the out-of-plane acceleration is shown being in a direction that goes into the plane. In other words, as the proof mass 1604 is unbalanced and is coupled to rotational springs, the accelerometer structure may tilt like a see-saw, in other words, alternately in and out of the plane, when out-of-plane acceleration is applied to the motion measurement device structure. For example, in a time instance, a first proof mass of the pair of proof masses 1604 may move out of the plane in a first direction when a second proof of the pair of proof masses 1604 moves out of the plane in a second direction, the second direction opposing the first direction. In a next time instance, the first proof mass may move out of the plane in the second direction when the second proof mass moves out of the plane in the first direction.

FIG. 17 shows a graph 1700 showing simulation results of the sensitivity of the motion measurement device 1600 using square resonators 992. The sensitivity simulation was conducted to check the mechanism of the motion measurement device 1600 using the same finite element analysis used on the in-plane accelerometer as shown in FIGS. 14 and 15. The square resonators 992 may be BAW resonators. The square resonators 992 are resonating in Lame mode. In other words, the graph 1700 shows the scale factor simulation of the motion measurement device 1600, wherein the resonators 1202A and 1202B are square resonators 992. The graph 1700 includes a horizontal axis 1702 and a vertical axis 1704. The horizontal axis 1702 may represent acceleration in units g. The vertical axis 1704 may represent frequency in Hz. The graph 1700 further includes a first plot 1706 indicating the oscillation frequencies of the first resonator 1202A; and a second plot 1708 indicating the oscillation frequencies of the second resonator 1202B. The gradient of the second plot 1708 is at least substantially equal to, or similar to, an opposite of the first plot 1706. Also, each of the first plot 1706 and the second plot 1708 may be linear. In other words, the oscillation frequency of each resonator may be at least substantially directly proportional to the acceleration experienced by the motion measurement device 1600. The scale factor of the out-of-plane sensing accelerometer may be lower than the scale factor of the in-plane accelerometer as shown in FIG. 14.

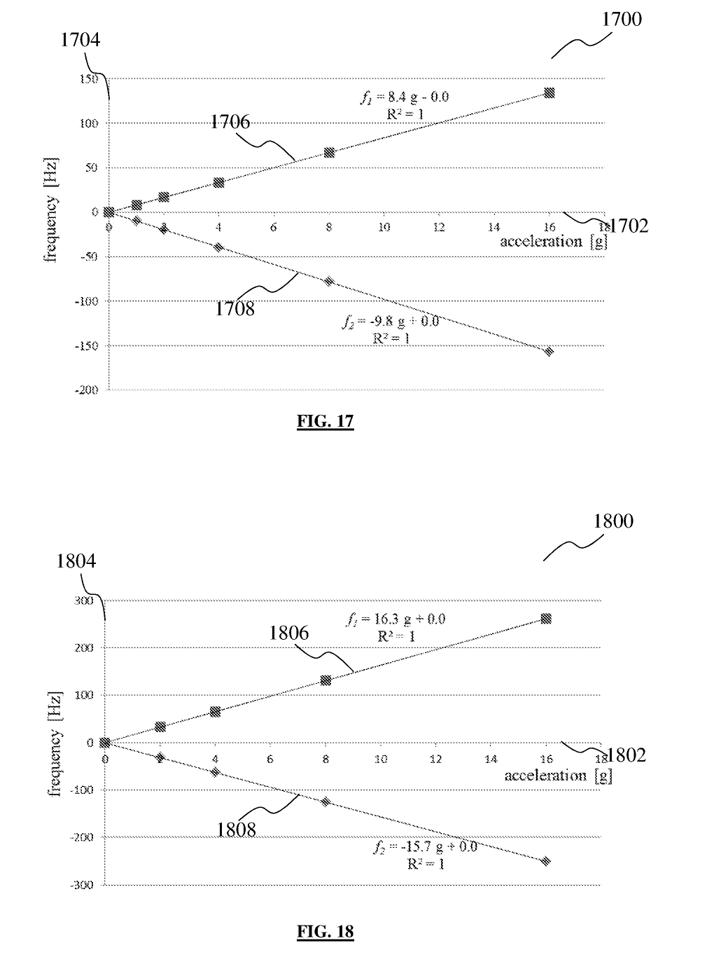

FIG. 18 shows a graph 1800 showing simulation results of the sensitivity of the motion measurement device 1600 using ring resonators 1012. The ring resonators 1012 are resonating in torsional wineglass mode. In other words, the graph 1800 shows the scale factor simulation of the motion measurement device 1600, wherein the resonators 1202A and 1202B are ring resonators 1012. The graph 1800 includes a horizontal axis 1802 and a vertical axis 1804. The horizontal axis 1802 may represent acceleration in units g. The vertical axis 1804 may represent frequency in Hz. The graph 1800 further includes a first plot 1806 indicating the oscillation frequencies of the first resonator 1202A; and a second plot 1808 indicating the oscillation frequencies of the second resonator 1202B. The gradient of the second plot 1808 is at least substantially equal to, or similar to, an opposite of the first plot 1806. Also, each of the first plot 1806 and the second plot 1808 may be linear. In other words, the oscillation frequency of each resonator may be at least substantially directly proportional to the acceleration experienced by the motion measurement device 1600. The scale factor of the out-of-plane sensing accelerometer may be lower than the scale factor of the in-plane accelerometer as shown in FIG. 15.

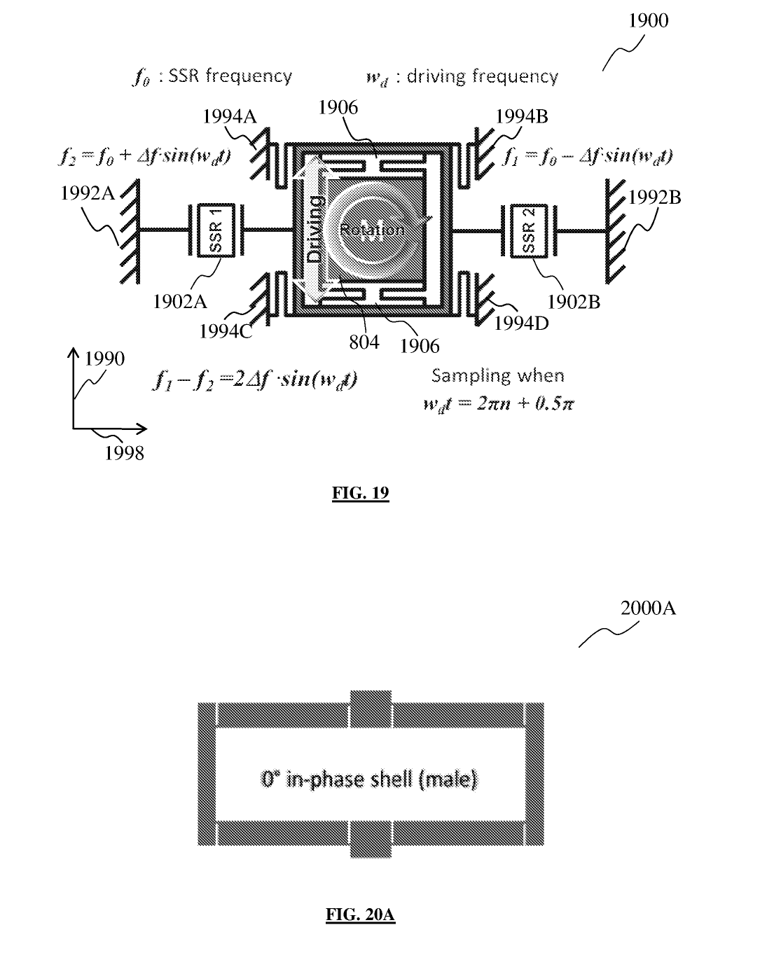

FIG. 19 shows a schematic diagram of a motion measurement device 1900 according to various embodiments. The motion measurement device 1900 may form part of the motion measurement devices 300 or 400. The motion measurement device 1900 may be a gyroscope, for example a frequency-modulated (FM) gyroscope. The motion measurement device 1900 may include a proof mass 804, and a pair of sensing resonators 1902A and 1902B. The pair of sensing resonators may be the pair of resonators 204, or 104 or 304. The sensing resonator 1902A may be at least substantially identical to the sensing resonator 1902B. The sensing resonators 1902A and 1902B may be configured to sense force. The proof mass 804 may be coupled to a pair of actuators 1906. The actuators 1906 may also be piezoelectric-driven. The actuators 1906 may be configured to drive the proof mass 804 to move along a first axis 1990. The first axis 1990 may be at least substantially perpendicular to a second axis 1998. The second axis 1998 may be at least substantially parallel to a distance between the sensing resonator 1902A and sensing resonator 1902B. The motion measurement device 1900 may further include yaw and roll/pitch gyro structures using the driving mechanical amplifiers. The piezoelectric driving actuator may include a pair of motion amplifiers for bidirectional anti-phase driving of two mirror-symmetric proof masses to amplify the actuation from piezoelectric material. The motion measurement device 1900 may include two different force sensitive resonators for direct sensing of Coriolis force exerted on the proof mass 804. The differential resonators may be placed in the inertial frame to compose the gyroscope structures to sense at least one of a yaw rate, roll rate and pitch direction.

According to various embodiments, a motion measurement device may be configured to determine an orientation, based on the Coriolis effect. The motion measurement device may be the motion measurement device 1900. The Coriolis force, denoted herein as F_{C}, may be defined as in Equation (1) where m denotes proof mass, Ω denotes the input rotational rate and v denotes the velocity of the proof mass.

F_{C}=−2mΩ·v (1)

As we can see from Equation (1), the mechanical scale factor of the gyroscope depends on the velocity of the proof mass, v. The velocity of the oscillating proof mass may need to be maximized in order to obtain high sensitivity and high resolution. Assuming the spring is within linear range, the relationship between the maximum velocity of the oscillating proof mass vₘₐₓ and the maximum displacement of the oscillating proof mass dₘₐₓ may be calculated from the energy conservation of the oscillation. As we can see from the Equation (2) where k denotes the spring constant, vₘₐₓ may be increased by increasing dₘₐₓ. The spring constant may be the spring constant of flexible couplers that elastically couple the proof mass to a fixed member or a frame, such that the proof mass may oscillate.

$$\begin{matrix}\frac{1}{2} {kd}_{max}^{ 2} = \frac{1}{2} {mv}_{max}^{2} & ( 2 ) \\ {v}_{max}^{2} = \sqrt{\frac{k}{m}} \cdot {d}_{max} & ( 3 )\end{matrix}$$

In general, piezoelectric material may possess desirable characteristics related to driving actuation. For example, piezoelectric material may have an inherent linear relation between supplying energy and generating power. Piezoelectric material may also provide sufficient strength to deform a rigid structure and to actuate the rigid structure bidirectionally. However one clear drawback of piezoelectric material in providing actuation, is its limited tolerance for static strain and dynamic strain. In other words, a piezoelectric drive mechanism may provide good strength but only a small deflection. To overcome the limitation of small strain in piezoelectric materials, a pair of motion amplifying structures may be used to realize single signal addressing for anti-phase bidirectional driving of paired proof masses.

According to various embodiments, a motion measurement device may include one or more motion amplifiers. The motion amplifiers may include at least one of an in-phase motion amplifier and an out-of-phase motion amplifier. The motion amplifiers may be coupled to a proof mass. The motion amplifiers may be configured to multiply the amount of deformation in the proof mass and may be further configured to oscillate the proof mass in an orthogonal direction from the original direction of movement actuated by the piezoelectric material.

According to various embodiments, a motion measurement device may include a pair of actuators. The pair of actuators may be coupled to a proof mass. The pair of actuators may be configured to push and pull the proof mass bi-directionally. One actuator of the pair of actuators may include a female structure, i.e. an anti-phase structure. The other actuator of the pair of actuators may include a male structure, i.e. an in-phase structure. The female structure may be an in-phase motion amplifier. The male structure may be an out-of-phase motion amplifier. The two actuators may be configured to drive the proof mass to move in opposing directions when the actuators receive the same alternating current driving signal. The movement, i.e. displacement of the proof mass may be amplified using rotational flexure hinges. The rotational flexure hinges may be intentionally misaligned, so as to provide a predetermined amplification ratio to the movement of the proof mass.

FIG. 20A shows an in-phase motion amplifier 2000A according to various embodiments. The in-phase motion amplifier 2000A may also be referred herein as a male amplifier. The in-phase motion amplifier 2000A may be a shell configured to be couplable to an actuator, for example a piezoelectric actuator.

FIG. 20B shows an out-of-phase motion amplifier 2000B according to various embodiments. The out-of-phase motion amplifier 2000B may also be referred herein as a female amplifier or an anti-phase motion amplifier. The out-of-phase motion amplifier 2000B may be a shell configured to be couplable to an actuator, for example a piezoelectric actuator.

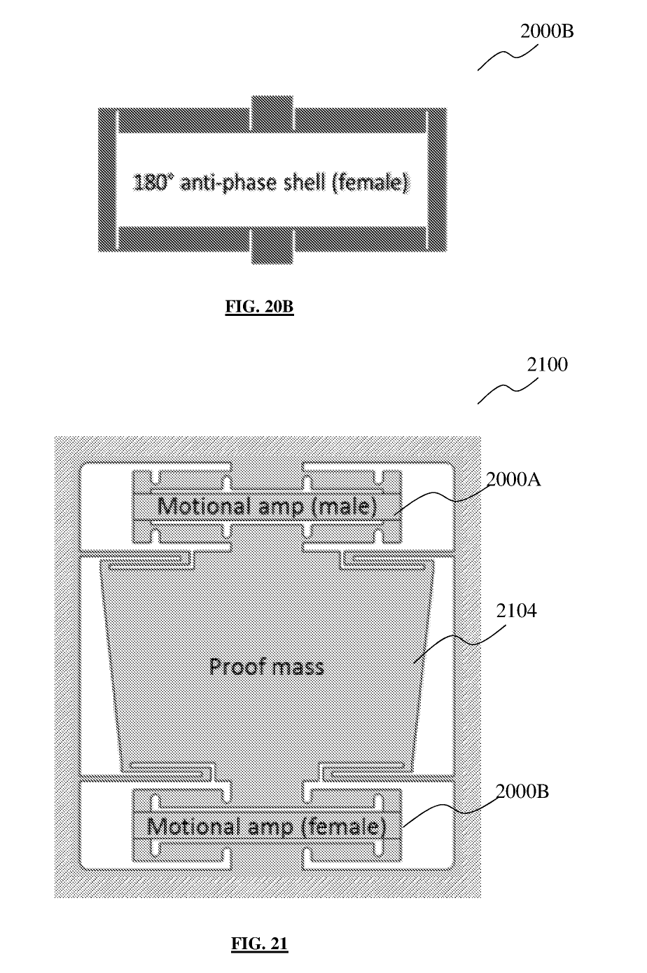

FIG. 21 shows a schematic diagram of a motion measurement device 2100 according to various embodiments. The motion measurement device 2100 may include a pair of anti-phase motion amplifiers and a proof mass 2104. The pair of anti-phase motion amplifiers may include an in-phase motion amplifier 2000A and an out-of-phase motion amplifier 2000B.

FIG. 22 shows a simulation diagram 2200 showing the stress load on the motion amplifiers of the motion measurement device 2100 when the proof mass 2104 is in motion. Each of the in-phase motion amplifier 2000A and the out-of-phase motion amplifier 2000B may be coupled to a respective piezoelectric belt. When an electrical current is passed through the piezoelectric belts, the piezoelectric belts may convert the electrical energy into mechanical movements, for example vibrations or deformation. The electrical current may be an alternating current so that the resulting movements in the piezoelectric belts also alternate in displacement directions. The motion amplifiers also move, vibrate or deform according to the movements of the piezoelectric belts, by virtue of being coupled to the piezoelectric belts. The pair of motion amplifiers may be configured to provide bi-directional actuation of the proof mass 2104. The mechanical amplifiers may be configured to multiply the motion of the proof mass 2104 in a direction at least substantially perpendicular to a plane of the proof mass 2104, i.e. out-of-plane motion. When the in-phase motion amplifier 2000A pushes the proof mass 2104 from a first side of the proof mass 2104, the out-of-phase motion amplifier pulls the proof mass 2104 from a second side of the proof mass 2104. The second side may oppose the first side.

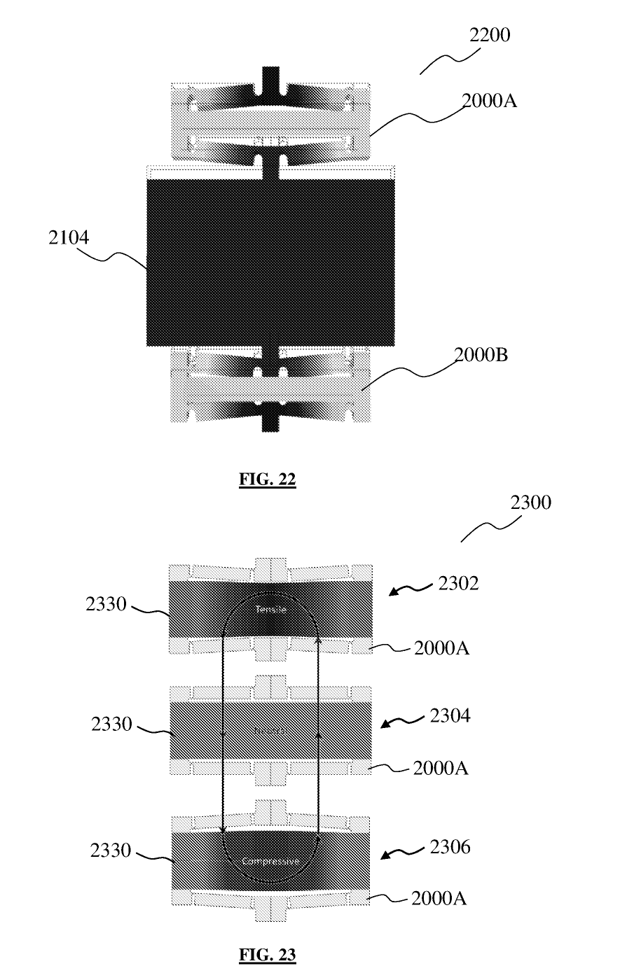

FIG. 23 shows a diagram 2300 showing the behaviour of an in-phase motion amplifier 2000A according to various embodiments. The in-phase motion amplifier 2000A may be coupled to a piezoelectric actuator 2330, also referred herein as piezoelectric belt. In 2302, the in-phase motion amplifier 2000A is shown in a tensile state, where two opposing sides of the in-phase motion amplifier 2000A are drawn inwards such that the distance between mid-points of the two opposing sides is shorter. In 2304, the in-phase motion amplifier 2000A is shown in a neutral state where the two opposing sides are parallel. In 2306, the in-phase motion amplifier 2000A is shown in a compressive state, where the two opposing sides are pushed outwards such that the distance between mid-points of the two opposing sides is wider.

According to various embodiments, a gyroscope may include a proof mass, resonators and actuators. The resonators may be configured to sense the Coriolis force acting on the proof mass. The resonators may be at least one of the square resonator 992 of FIG. 9 or the ring resonator 1012 of FIG. 10. The square resonator 992 may resonate in Lame mode. The ring resonator 1012 may resonate in torsional wine glass mode. The description and simulation results of the square resonator 992 and the ring resonator 1012 in the above paragraphs may also be applicable to the resonators of the gyroscope.

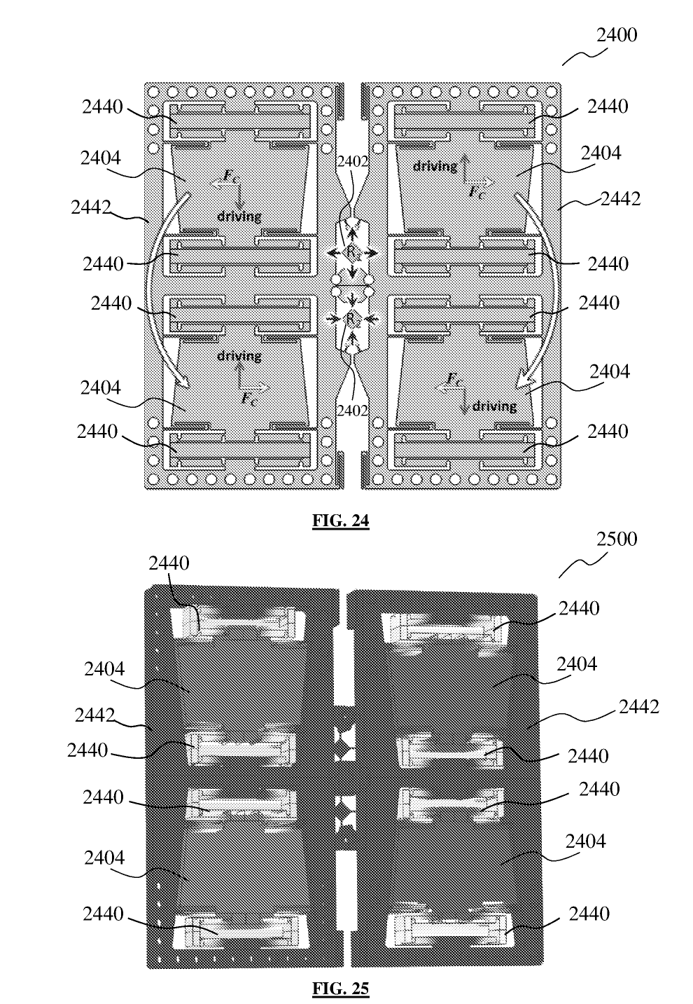

FIG. 24 shows a motion measurement device 2400 according to various embodiments. The motion measurement device 2400 may be at least substantially identical or similar to the motion measurement device 300. The motion measurement device may be an in-plane gyroscope or a yaw rate sensor. The motion measurement device 2400 may include differential FSRs. The motion measurement device 2400 may include two inertial frames 2442 which may be the first frame 308A and the second frame 308B. The inertial frames 2442 may be capable of being twisted in-plane. In other words, the inertial frames 2442 may be torsional in-plane. The motion measurement device 2400 may further include proof masses 2404. Each inertial frame 2442 may be coupled to a pair of proof masses 2404. The pair of proof masses 2404 may be the first pair of proof masses 302A and the second pair of proof masses 302B. Each pair of proof masses 2404 may include a first proof mass driven to move in a first direction and a second proof mass driven to move in a second direction, wherein the second direction opposes the first direction. Each of the first direction and the second direction may be at least substantially in-plane, i.e. parallel to a plane of the inertial frames 2442 when the inertial frames 2442 are not twisted. Each proof mass 2404 may be connected to two motion amplifiers 2440. The motion amplifiers 2440 may be identical to, or similar to, an in-phase amplifier 2000A or an anti-phase amplifier 2000B. The inclusion of the pair of anti-phase driven proof masses 2404 may increase the driving efficiency. The scale factor of the motion measurement device 2400 has been simulated using FEM simulation. The motion measurement device 2400 may further include driver circuits which may include the first driver circuit 210A and the second driver circuit 210B. The inertial frames 2442 are configured to either squeeze or stretch the differential resonators R₁ and R₂ periodically at the same frequency with the driver circuits. The direction of the actuation provided by the driver circuits is labeled as “driving” in FIG. 24. The direction of the Coriolis force is labeled as “F_{C}” in FIG. 24. The inertial frames 2442 may also amplify the Coriolis force and push or pull the connecting rods of the resonators.

FIG. 25 shows a diagram 2500 of the FEM simulation of the motion measurement device 2400. The FEM simulation was used to simulate the scale factor of the motion measurement device 2400. The simulated scale factor is about 5 Hz/°/s.

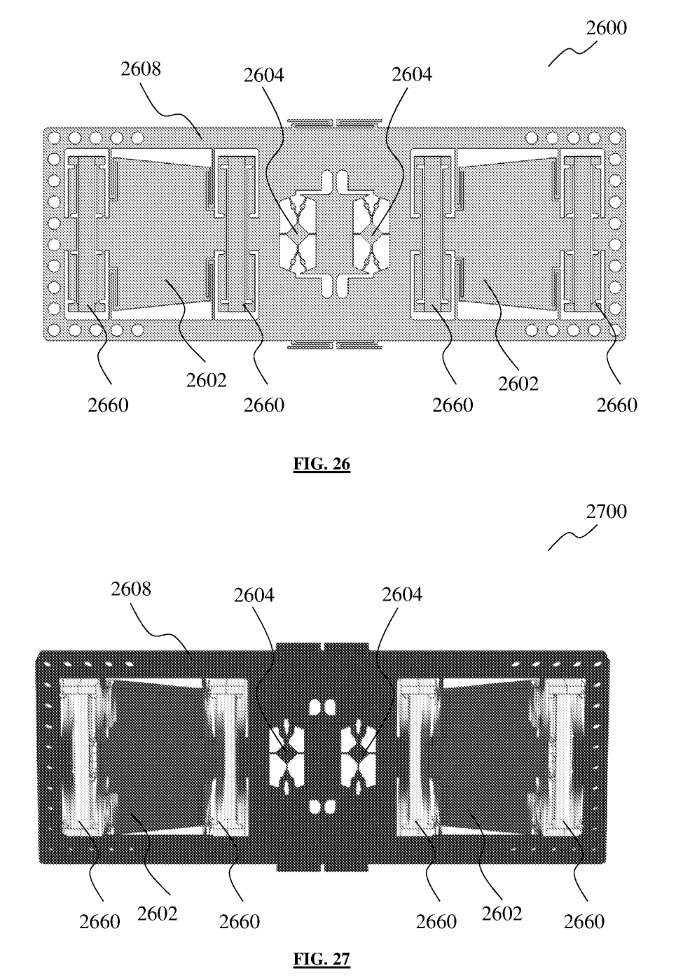

FIG. 26 shows a motion measurement device 2600 according to various embodiments. The motion measurement device 2600 may be at least substantially identical or similar to the motion measurement device 400. The motion measurement device 2600 may be a roll/pitch gyroscope. In other words, the motion measurement device 2600 may be configured to sense an out-of-plane rotation. FIG. 26 shows the physical shape of the motion measurement device 2600. The motion measurement device 2600 may include a frame 2608, a pair of resonators 2604, a pair of proof masses 2602, a determination circuit and a driver circuit. The frame 2608 may be identical or similar to the frame 408. The pair of resonators 2604 may be identical or similar to the pair of resonators 404. The pair of proof masses 2602 may be identical or similar to the pair of proof masses including the first proof mass 402A and the second proof mass 402B. The driver circuit may include motion amplifiers 2660. The motion amplifiers 2660 may be identical to, or similar to, an in-phase amplifier 2000A or an anti-phase amplifier 2000B. The out-of-plane sensing capability may be achieved by placing differential resonators of the pair of resonators 2604 on either side of torsional springs, allowing the proof masses to rotate in roll or pitch direction. The proof masses 2602 may be symmetric but may be driven in anti-phases. In other words, one proof mass may be driven to move in an opposite direction from the other proof mass. This may result in a see-saw mode tilting of the proof masses when roll or pitch rate is applied. The scale factor from the roll/pitch gyroscope may be lower than the motion measurement device 2400. The frame 2608 may allow rotational freedom in the pitch or roll direction which may be perpendicular to the driving force provided by the driver circuit. The resonators 2604 may be placed near the rotational center of the motion measurement device 2600, to respond to the rotational strain. Simulated scale factor from the roll/pitch sensor with 1×1 mm² may be about 5 Hz/°/s.

FIG. 27 shows a diagram 2700 of the FEM simulation of the motion measurement device 2600. The FEM simulation was performed to characterize the frequency scale factor of the motion measurement device 2600. For the simulation, the force sensing resonators of the motion measurement device were assumed to be resonating in Lame mode. The force sensing resonators may be square resonators. The simulated sensitivity is around 0.7 Hz/°/s.

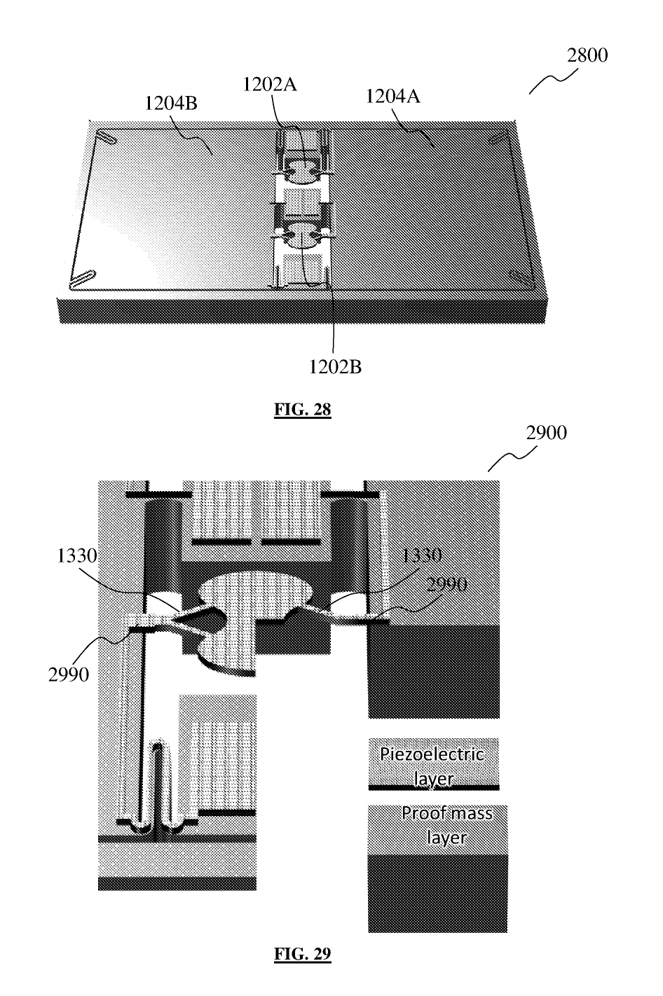

FIG. 28 shows a diagram of a motion measurement device 2800 according to various embodiments. The motion measurement device 2800 may be an in-plane accelerometer. The motion measurement device 2800 may be the motion measurement device 100 or the motion measurement device 1200. The motion measurement device 2800 may include a first proof mass 1204A and a second proof mass 1204B. The motion measurement device 2800 may further include a pair of resonators. The pair of resonators includes a first resonator 1202A and a second resonator 1202B.

FIG. 29 shows an enlarged view 2900 of the resonators of the motion measurement device 2800. The pair of resonators may be coupled to each of the first proof mass 1204A and the second proof mass 1204B via coupling members. The coupling members may include flexure hinges 1330. The flexure hinge 1330 may be a thin tether that connects the resonators to levers 2990 that are coupled to the first mass 1204A and the second mass 1204B. The levers may include a slope to amplify any force received. The rotation of the pair of proof masses may be limited to a rotation plane, the rotation plane being at least substantially parallel to a plane in which the acceleration occurs.

While embodiments of the invention have been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced. It will be appreciated that common numerals, used in the relevant drawings, refer to components that serve a similar or the same purpose.

1. A motion measurement device comprising:
a first proof mass and a second proof mass, each of the first proof mass and the second proof mass configured to be at least partially rotatable in-plane;
wherein the first proof mass and the second proof mass are configured to rotate in mirrored directions in response to in-plane accelerations;
a pair of resonators arranged between the first proof mass and the second proof mass such that each of the first proof mass and the second proof mass symmetrically interacts with each resonator of the pair of resonators; wherein a first resonator of the pair of resonators is configured to resonate at a first frequency and a second resonator of the pair of resonators is configured to resonate at a second frequency; and
a determination circuit configured to determine an acceleration based on the first frequency and the second frequency.

2. The motion measurement device of claim 1, wherein each of the first proof mass and the second proof mass is coupled to an anchor arranged between the first proof mass and the second proof mass.

3. The motion measurement device of claim 2, wherein each of the first proof mass and the second proof mass is coupled to the anchor via rigid coupling elements.

4. The motion measurement device of claim 1, wherein the first proof mass is at least substantially identical to the second proof mass.

5. The motion measurement device of claim 1, wherein each of the first resonator and the second resonator is coupled to each of the first proof mass and the second proof mass.

6. The motion measurement device of claim 1, wherein the first resonator is coupled to the first proof mass via a first flexible coupler and the second resonator is coupled to the second proof mass via a second flexible coupler.

7. The motion measurement device of claim 6, wherein each of the first flexible coupler and the second flexible coupler comprises a lever and a flexure hinge, wherein the lever is coupled to one of the first proof mass or the second proof mass, and wherein the flexure hinge is coupled to one of the first resonator or the second resonator.

8. The motion measurement device of claim 1, wherein the first resonator and the second resonator are a same type of resonator.

9. The motion measurement device of claim 1, wherein each of the first resonator and the second resonator comprises piezoelectric material.

10. A method for measuring motion, the method comprising:
providing a first proof mass and a second proof mass, each of the first proof mass and the second proof mass configured to be at least partially rotatable in-plane,
wherein the first proof mass and the second proof mass are configured to rotate in mirrored directions in response to in-plane accelerations;
arranging a pair of resonators between the first proof mass and the second proof mass such that each of the first proof mass and the second proof mass symmetrically interacts with each resonator of the pair of resonators;
wherein a first resonator of the pair of resonators is configured to resonate at a first frequency and a second resonator of the pair of resonators is configured to resonate at a second frequency; and
determining an acceleration based on the first frequency and the second frequency.

11. A motion measurement device comprising:
a first frame and a second frame, each of the first frame and the second frame configured to be at least partially rotatable in-plane;
a first pair of proof masses arranged within the first frame and a second pair of proof masses arranged within the second frame;
a first driver circuit configured to drive the first pair of proof masses to oscillate in antiphase;
a second driver circuit configured to drive the second pair of proof masses to oscillate in antiphase;
a pair of resonators arranged between the first frame and the second frame;
wherein a first resonator of the pair of resonators is configured to resonate at a first frequency and a second resonator of the pair of resonators is configured to resonate at a second frequency; and
a determination circuit configured to determine a rotational rate, based on the first frequency, the second frequency and an oscillation rate of each of the first pair of proof masses and the second pair of proof masses.

12. The motion measurement device of claim 11, wherein the first driver circuit is configured to drive the first pair of proof masses to oscillate in-plane, and wherein the second driver circuit is configured to drive the second pair of proof masses to oscillate in-plane.

13. The motion measurement device of claim 11, wherein the second driver circuit is configured to drive the second pair of proof masses to oscillate in antiphase relative to the first pair of proof masses.

14. The motion measurement device of claim 11, wherein each of the first frame and the second frame is coupled to a fixed member by torsional couplers.

15. The motion measurement device of claim 11, wherein the first pair of proof masses are symmetrically arranged in the first frame and the second pair of proof masses are symmetrically arranged in the second frame.

16. The motion measurement device of claim 11, wherein each of the first driver circuit and the second driver circuit comprises motion amplifiers and actuating elements.

17. The motion measurement device of claim 16, wherein the actuating elements comprise piezoelectric material.

18. The motion measurement device of claim 16, wherein motion amplifiers of the first driver circuit are coupled to the first pair of proof masses and the actuating elements of the first driver circuit, and wherein motion amplifiers of the second driver circuit are coupled to the second pair of proof masses and the actuating elements of the second driver circuit.

19. The motion measurement device of claim 16, wherein the motion amplifiers of the first driver circuit are configured to multiply an amount of deformation in the first pair of proof masses and, wherein the motion amplifiers of the second driver circuit are configured to multiply an amount of deformation in the second pair of proof masses.

20. A method for measuring motion, the method comprising:
providing a first frame and a second frame, each of the first frame and the second frame configured to be at least partially rotatable in-plane;
arranging a first pair of proof masses within the first frame;
arranging a second pair of proof masses within the second frame;
driving each of the first pair of proof masses and the second pair of proof masses to oscillate in antiphase;
arranging a pair of resonators between the first frame and the second frame;
wherein a first resonator of the pair of resonators is configured to resonate at a first frequency and a second resonator of the pair of resonators is configured to resonate at a second frequency; and
determining a rotational rate based on the first frequency, the second frequency, an oscillation rate of the first pair of proof masses and an oscillation rate of the second pair of proof masses.
